(19) United States
(12) Patent Application Publication
(10) Pub. No.: US 2020/0218042 A1
(43) Pub. Date: Jul. 9, 2020

(54) PROJECTION OPTICAL SYSTEM AND PROJECTION TYPE DISPLAY APPARATUS INCLUDING THE SAME

(71) Applicant: CANON KABUSHIKI KAISHA, Tokyo (JP)

(72) Inventor: Yosuke Sakai, Utsunomiya-shi (JP)

(21) Appl. No.: 16/734,228

(22) Filed: Jan. 3, 2020

(30) Foreign Application Priority Data
Jan. 8, 2019 (JP) 2019-000955

(51) Int. Cl. G02B 15/173; G03B 21/14

(52) U.S. Cl. CPC G02B 15/173; G03B 21/142

(57) ABSTRACT

A projection optical system includes, in order from an enlargement conjugate side to a reduction conjugate side, a first optical system and a second optical system, in which the projection optical system has an intermediate imaging position between the first optical system and the second optical system, an enlargement side lens unit included in the first optical system and a reduction side lens unit included in the second optical system are moved on an optical axis to adjust a curvature of field of an image projected onto the enlargement conjugate side, and a focal length of the projection optical system and a distance between a surface vertex of a surface closest to a reduction side of the enlargement side lens unit and the intermediate imaging position of the projection optical system with respect to a d-line wavelength at being focused on infinity are appropriately set.

### BACKGROUND

### Field of the Disclosure

The present disclosure generally relates to a projection optical system to be used for a projection type display apparatus (projector) configured to perform enlarged projection of, for example, an image onto a screen, and more particularly, to a projection optical system having a wide projection angle of field.

### Description of the Related Art

Hitherto, projection type display apparatus have been developed in various forms to obtain a high sense of presence. For example, a projection type display apparatus is used to project a video onto a dome screen, and a wide angle of field is formed for a viewer, to thereby attempt to give a high production effect. Further, a projection optical system to be used for a projection type display apparatus may often have a large projection screen at a short projection distance, and thus projection at a wide angle of field may be needed to be performed easily.

A general projection type display apparatus is designed such that an image plane of a projection optical system becomes as close to a plane as possible in order to enable an image to be focused on the entire screen of the plane. Thus, when an image is projected onto, for example, a screen having a curvature to obtain a sense of presence, a position in focus, for example, the center of the screen, can be focused on, whereas image blur occurs at other positions depending on a difference from the plane.

Hitherto, there has been known a projection optical system designed to enable an image to be focused on the entire screen being a curved surface (Japanese Patent 2017-49422). In Japanese Patent Application Laid-Open No. 2017-126036 and Japanese Patent Application Laid-Open No. 2017-49422, a lens unit is moved in accordance with an average curvature of the screen to cause a curvature of field, to thereby enable an image to be focused on the entire projected image similarly to the case of projecting an image onto a plane even when an image is projected onto a screen that has a curvature.

### SUMMARY

According to at an aspect of the present disclosure, a projection optical system includes, in order from an enlargement conjugate side to a reduction conjugate side, a first optical system and a second optical system, in which the projection optical system has an intermediate imaging position between the first optical system and the second optical system, and an enlargement side lens unit included in the first optical system and a reduction side lens unit included in the second optical system are moved on an optical axis to adjust a curvature of field of an image projected onto the enlargement conjugate side, and a conditional expression

4.0<|dF/f|<15.0,

is satisfied in a case where f represents a focal length of the projection optical system, and dF represents a distance between a surface vertex of a surface closest to a reduction side of the enlargement side lens unit and the intermediate imaging position of the projection optical system with respect to a d-line wavelength at being focused on infinity.

Further features of the present disclosure will become apparent from the following description of exemplary embodiments with reference to the attached drawings.

### BRIEF DESCRIPTION OF THE DRAWINGS

FIG. 1 is a lens cross-sectional view of a projection optical system according to Embodiment 1 of the present disclosure.

FIG. 2A is a graph for showing an MTF/defocus characteristic in plane projection of the projection optical system according to Embodiment 1.

FIG. 2B is a graph for showing an MTF/defocus characteristic in curved surface projection of the projection optical system according to Embodiment 1.

FIG. 2C is a graph for showing an MTF/defocus characteristic in the curved surface projection in a case where a curvature of field of the projection optical system according to Embodiment 1 is adjusted.

FIG. 3 is a lens cross-sectional view of a projection optical system according to Embodiment 2 of the present disclosure.

FIG. 4A is a graph for showing an MTF/defocus characteristic in the plane projection of the projection optical system according to Embodiment 2.

FIG. 4B is a graph for showing an MTF/defocus characteristic in the curved surface projection of the projection optical system according to Embodiment 2.

FIG. 4C is a graph for showing an MTF/defocus characteristic in the curved surface projection in a case where the curvature of field of the projection optical system according to Embodiment 2 is adjusted.

FIG. 5 is a lens cross-sectional view of a projection optical system according to Embodiment 3 of the present disclosure.

FIG. 6A is a graph for showing an MTF/defocus characteristic in the plane projection of the projection optical system according to Embodiment 3.

FIG. 6B is a graph for showing an MTF/defocus characteristic in the curved surface projection of the projection optical system according to Embodiment 3.

FIG. 6C is a graph for showing an MTF/defocus characteristic in the curved surface projection in a case where the curvature of field of the projection optical system according to Embodiment 3 is adjusted.

FIG. 7 is a schematic diagram for illustrating a projection type display apparatus according to at least one embodiment of the present disclosure.

FIG. 8 is an explanatory diagram for illustrating a hemisphere screen that uses two projection optical systems according to Embodiment 1.

### DESCRIPTION OF THE EMBODIMENTS

Various exemplary embodiments, aspects, and features of the present disclosure will be described below with reference to the accompanying drawings.

When a projection angle of field is set to have a wider angle of field in a projection optical system having a function of adjusting a curvature of field, an effective diameter of a lens unit that adjusts the curvature of field becomes larger. In particular, in a retrofocus type projection optical system, with which an image can be easily projected at a wide angle of field, as the angle of field becomes wider, the lens diameter of a lens unit that adjusts the curvature of field becomes larger. As the effective diameter of the lens unit adjusts the curvature of field becomes larger, the weight of the lens unit becomes larger, resulting in a difficulty in quickly adjusting the curvature of field.

The present disclosure has an object to provide a projection optical system and a projection type display apparatus including the projection optical system, which have a function of adjusting a curvature of field, and achieve downsizing of the entire projection optical system even in projection at a wide angle of field, and with which a lens unit that adjusts the curvature of field, in particular, is easily downsized.

The projection optical system according to each Embodiment of the present disclosure is arranged on a reduction conjugate side, and projects an image displayed on an image display element onto an enlargement conjugate side.

The projection optical system may include a first optical system and a second optical system in order from the enlargement conjugate side to the reduction conjugate side. The projection optical system includes an intermediate imaging position between the first optical system and the second optical system. The first optical system includes an enlargement side lens unit that is moved on an optical axis, and the second optical system includes a reduction side lens unit that is moved on the optical axis. The enlargement side lens unit and the reduction side lens unit are moved in an optical-axis direction, to thereby adjust a curvature of field of an image projected onto the enlargement conjugate side.

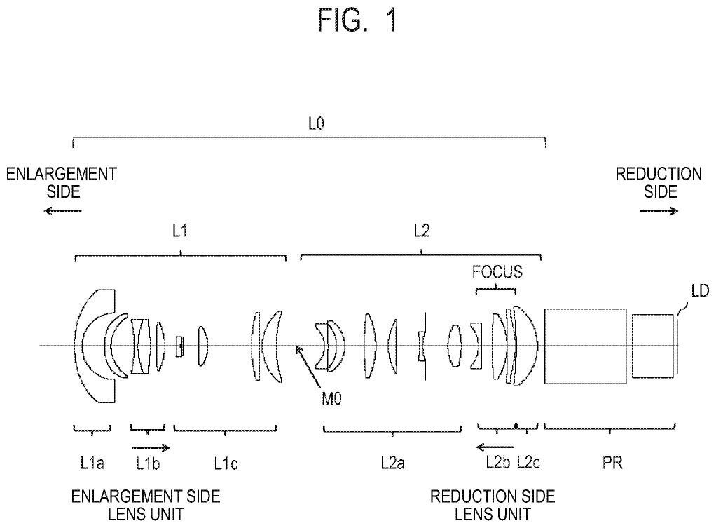

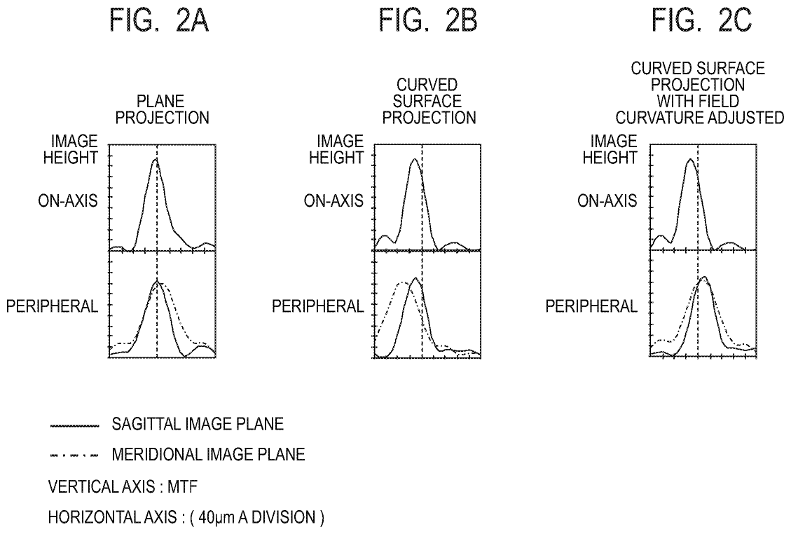

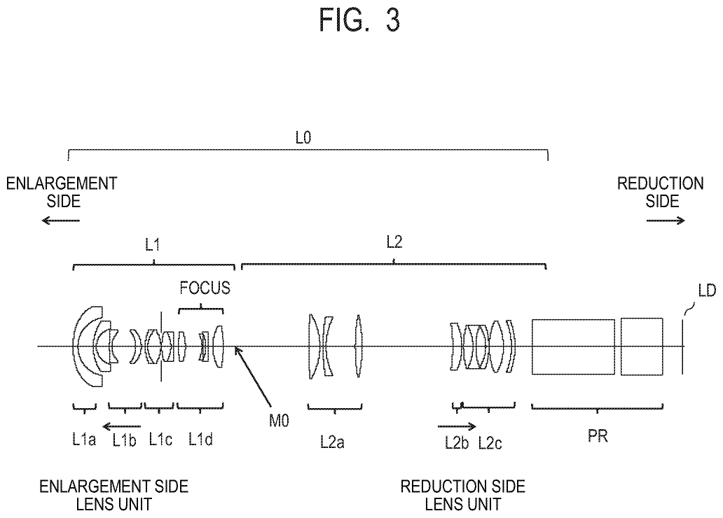

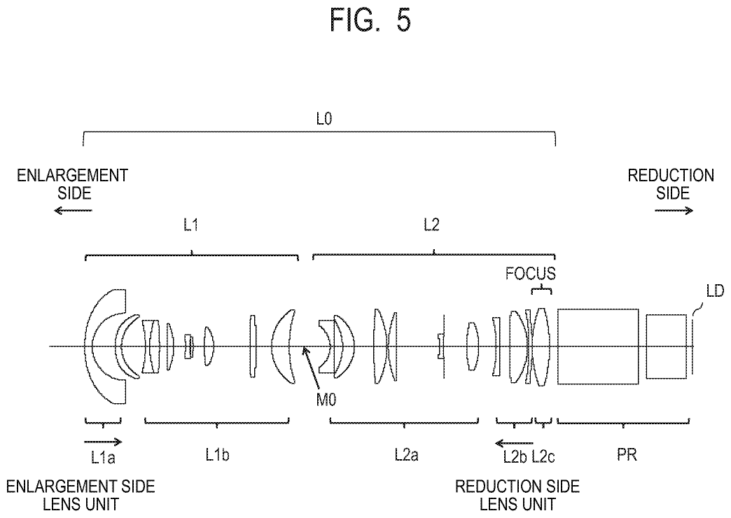

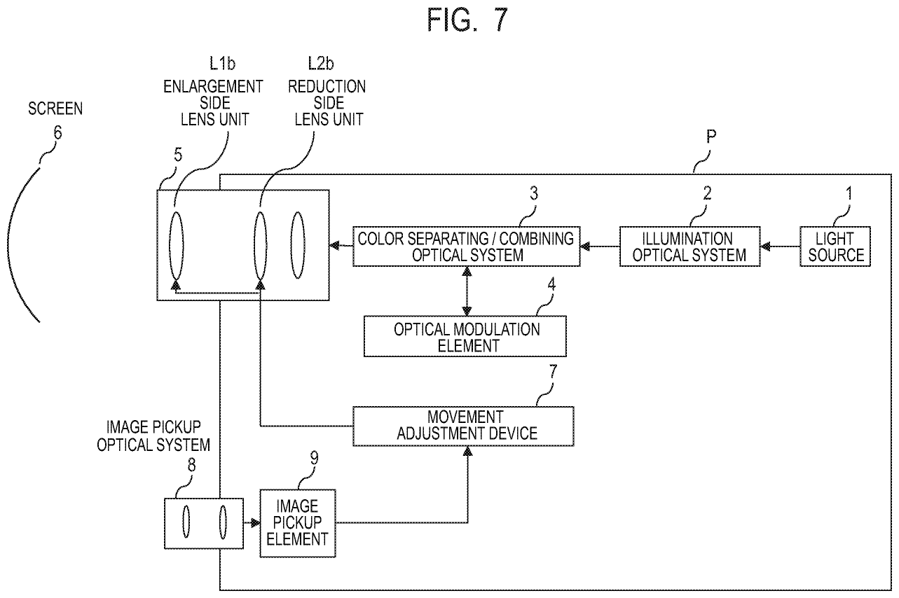

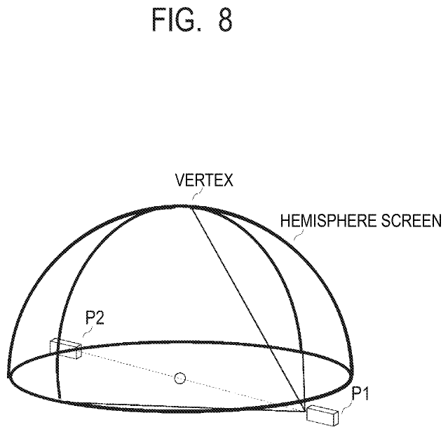

FIGS. 1, 3, and 5 are lens cross-sectional views of projection optical systems according to Embodiments 1 to 3 of the present disclosure, respectively. FIGS. 2A, 2B, 2C, 4A, 4B, 4C, 6A, 6B, and 6C are graphs for showing MTF/defocus characteristics of the projection optical systems according to Embodiments 1 to 3 of the present disclosure, respectively. FIG. 7 is a schematic diagram for illustrating main components of a projection type display apparatus according to at least one embodiment of the present disclosure. FIG. 8 is an explanatory diagram for illustrating a hemisphere screen that uses the two projection optical systems according to at least one embodiment of the present invention.

In the lens cross-sectional views, L0 represents a projection optical system. L1 and L2 represent a first optical system and a second optical system, respectively. L1a, L1b, L1c, and L1d represent an L1a lens unit, an L1b lens unit, an L1c lens unit, and an L1d lens unit, respectively. L2a, L2b, and L2c represent an L2a lens unit, an L2b lens unit, and an L2c lens unit, respectively. LD represents an image display element, and is formed of, for example, a liquid crystal panel, and a projected image is arranged on the image display element.

Next, a configuration of a projection optical system according to each Embodiment of the present disclosure is described.

The projection optical system L0 according to each Embodiment projects light of an image (image display surface) onto a projected surface (screen). The curvature of field of a projected image is adjusted in accordance with the shape (e.g., concave shape or convex shape) of the projected surface, for example. The projection optical system L0 according to each Embodiment includes the first optical system L1 and the second optical system L2 in order from an enlargement side (screen side) (projected surface side) to a reduction side (image display surface side).

In the projection optical system, an image of an enlarged conjugate point on the enlargement side is formed at the intermediate imaging position between the first optical system L1 and the second optical system L2, and the image formed at the intermediate imaging position is formed again at the reduced conjugate point on the reduction side. The first optical system L1 includes at least one enlargement side lens unit, and the second optical system L2 includes at least one reduction side lens unit. The enlargement side lens unit and the reduction side lens unit move in the optical-axis direction to adjust the curvature of field.

Each Embodiment relates to a projection optical system in which an image of the enlargement side conjugate point is formed in the projection optical system L0, and the formed image is formed again at the reduction side conjugate point. Herein, the conjugate point between the first optical system L1 and the second optical system L2 on the optical axis is referred to as an “intermediate imaging position M0”. In the projection optical system L0, the first optical system L1 corresponds to a wide angle portion, and the second optical system L2 corresponds to a relay portion.

The first optical system L1 in each Embodiment is a reduction optical system, and forms a reduced image of the enlarged conjugate point as an intermediate formed image. The second optical system L2 forms the intermediate formed image at the reduced conjugate point. With this, the lens diameter of the first optical system L1 on the enlargement side is reduced.

In each Embodiment, a lens unit that adjusts a curvature of field is arranged in both of the first optical system L1 and the second optical system L2, and the enlargement side lens unit and the reduction side lens unit are moved in the optical-axis direction, to thereby adjust the curvature of field of the projected image. Through this setting, the unit that adjusts the curvature of field is a lens unit having a small lens diameter and a high sensitivity of the curvature of field in both of the enlargement side lens unit and the reduction side lens unit. As a result, a projection optical system in which a lens unit that adjusts the curvature of field is downsized is obtained.

When only one lens unit is used to adjust the curvature of field, it is difficult to adjust only the curvature of field while suppressing other aberrations. The function of adjusting the curvature of field is provided in both of the enlargement side lens unit and the reduction side lens unit, to thereby obtain a satisfactory image while suppressing variation of aberrations other than the curvature of field.

When a plurality of lens units that adjusts the curvature of field with only the first optical system L1 are provided, the first optical system L1 becomes larger, and thus the lens unit that adjusts the curvature of field is upsized, which is not preferred. For example, a plurality of mechanisms for moving the lens units in the optical-axis direction to adjust the curvature of field may be constructed in the first optical system L1, and an interval between the lens units may be set large, with the result that the first optical system L1 is upsized. The projection optical system L0 enabling downsizing of the lens unit that adjusts the curvature of field is obtained by providing the adjustment function in both of the enlargement side lens unit and the reduction side lens unit.

Further, when a plurality of lens units that adjusts the curvature of field with only the second optical system L2 are provided, the sensitivity of the curvature of field of the lens unit is not high, and thus only a slight change in curvature of field is obtained. Thus, the function of adjusting the curvature of field is not obtained, which is not preferred. It is possible to obtain the projection optical system L0 including a lens unit having a high sensitivity of curvature of field by providing the adjustment function in both of the enlargement side lens unit and the reduction side lens unit.

In each Embodiment, a focal length of the projection optical system L0 is represented by “f”, and a focal length of the enlargement side lens unit is represented by fF. A focal length of the reduction side lens unit is represented by fR. A distance between a surface vertex of a surface closest to the reduction side of the enlargement side lens unit and the intermediate imaging position of the projection optical system L0 with respect to a d-line wavelength at the time of focus on infinity is represented by dF. A distance between the intermediate imaging position of the projection optical system L0 with respect to a d-line wavelength at the time of focus on infinity and a surface vertex of a surface closest to the enlargement side of the reduction side lens unit is represented by dR.

At this time, it is preferred to satisfy at least one of the following conditional expressions.

1.5<|fF/f|<10.0 (1)

6.0<|fR/f|<40.0 (2)

4.0<|dF/f|<15.0 (3)

8.0<|dR/f|<15.0 (4)

Next, technical meanings of the respective conditional expressions are described.

When the value of Conditional Expression (1) falls below the lower limit thereof, the focal length of the enlargement side lens unit becomes too short compared with the focal length of the projection optical system L0 at the wide angle end. Then, the change in aberration other than a curvature of field aberration becomes larger when the enlargement side lens unit has moved in the optical-axis direction, which is not preferred.

When the value of Conditional Expression (1) exceeds the upper limit thereof, the focal length of the enlargement side lens unit becomes too large compared with the focal length of the projection optical system L0 at the wide angle end. Then, only the slight change in curvature of field is obtained when the enlargement side lens unit has moved in the optical-axis direction, which is not preferred.

Thus, the curvature of field is easily adjusted by setting the focal length of the enlargement side lens unit so as to satisfy Conditional Expression (1).

It is preferred that Conditional Expression (1) satisfy Conditional Expression (1a) given below.

2.2<|fF/f|<6.5 (1a)

It is more preferred that Conditional Expression (1a) satisfy Conditional Expression (1b) given below.

2.2<|fF/f|<3.6 (1b)

When the value of Conditional Expression (2) falls below the lower limit thereof, the focal length of the reduction side lens unit becomes too short compared with the focal length of the projection optical system L0 at the wide angle end. Then, the change in aberration other than a curvature of field aberration becomes larger when the enlargement side lens unit has moved in the optical-axis direction, which is not preferred. When the value of Conditional Expression (2) exceeds the upper limit thereof, the focal length of the reduction side lens unit becomes too large compared with the focal length of the projection optical system L0 at the wide angle end. Then, only the slight change in curvature of field is obtained when the reduction side lens unit has moved in the optical-axis direction, which is not preferred.

Thus, the curvature of field is easily adjusted by setting the focal length of the reduction side lens unit so as to satisfy Conditional Expression (2).

It is preferred that Conditional Expression (2) satisfy Conditional Expression (2a) given below.

8.0<|fF/f|<35.0 (2a)

It is more preferred that Conditional Expression (2a) satisfy Conditional Expression (2b) given below.

10.0<|fF/f|<32.0 (2b)

When the value of Conditional Expression (3) falls below the lower limit thereof, the intermediate imaging position MO of the projection optical system L0 and the enlargement side lens unit become too close to each other. Thus, the enlargement side lens unit becomes away from an aperture surface of the projection optical system L0 in the first optical system L1 or a conjugate surface of an aperture surface of the projection optical system L0 in the second optical system L2, and the height from the optical axis of the off-axis principal ray entering the enlargement side lens unit becomes too high. As a result, the lens diameter of the enlargement side lens unit becomes larger, which is not preferred.

When the value of Conditional Expression (3) exceeds the upper limit thereof, the intermediate imaging position M0 of the projection optical system L0 and the enlargement side lens unit become too far away from each other. As a result, the first optical system L1 is upsized, and this causes the projection optical system L0 to be upsized, which is not preferred.

It is preferred that Conditional Expression (3) satisfy Conditional Expression (3a) given below.

5.0<|dF/f|<12.0 (3a)

It is more preferred that Conditional Expression (3a) satisfy Conditional Expression (3b) given below.

5.5<|dF/f|<10.8 (3b)

When the value of Conditional Expression (4) falls below the lower limit thereof, the intermediate imaging position of the projection optical system L0 and the reduction side lens unit become too close to each other. Thus, the reduction side lens unit becomes away from an aperture surface of the projection optical system in the second optical system L2 or a conjugate surface of an aperture surface of the projection optical system L0 in the first optical system L1, and the height from the optical axis of the off-axis principal ray entering the reduction side lens unit becomes too high. As a result, the lens diameter of the reduction side lens unit becomes larger, which is not preferred.

When the value of Conditional Expression (4) exceeds the upper limit thereof, the distance between the intermediate imaging position MO of the projection optical system L0 and the reduction side lens unit becomes too large. As a result, the second optical system L2 is upsized, and this causes the projection optical system L0 to be upsized, which is not preferred.

It is preferred that Conditional Expression (4) satisfy Conditional Expression (4a) given below.

10.0<|dR/f|<13.0 (4a)

It is more preferred that Conditional Expression (4a) satisfy Conditional Expression (4b) given below.

11.0<|dR/f|<12.7 (4b)

Next, the projection optical system L0 according to each Embodiment of the present disclosure is described.

The projection optical system L0 according to each Embodiment of the present disclosure is a projection optical system designed for a projection type display apparatus, and projects light modulated by a liquid crystal panel LD (optical modulation element) onto a screen (projected surface) (not shown). A prism glass PR, which does not have a refractive power, is arranged between the projection optical system L0 and the liquid crystal panel LD on the most reduction side. The prism glass PR may be used for a purpose of color composition and other purposes in a projector.

In the lens cross-sectional views, the left side of the drawing sheet corresponds to the enlargement side, and the right side of the drawing sheet corresponds to the reduction side. The projection optical system L0 includes the first optical system L1 and the second optical system L2 in order from the enlargement side. The intermediate imaging position M0 is positioned between the first optical system L1 and the second optical system L2. The screen surface is an enlargement side image formation screen, and the liquid crystal panel LD is a reduction side image formation screen.

In Embodiment 1, the first optical system L1 includes an L1a lens unit L1a and an enlargement side lens unit L1b in order from the enlargement conjugate side to the reduction conjugate side. The L1a lens unit L1a has a negative refractive power, and is configured not to move during adjustment of the curvature of field. Further, the first optical system L1 includes an L1c lens unit L1c having a positive refractive power, which is configured not to move during adjustment of the curvature of field. The enlargement side lens unit L1b has a positive refractive power.

The second optical system L2 includes an L2a lens unit L2a, a reduction side lens unit L2b, and an L2c lens unit L2c in order from the enlargement conjugate side to the reduction conjugate side. The L2a lens unit L2a has a positive refractive power, and is configured not to move during adjustment of the curvature of field. The L2c lens unit L2c has a positive refractive power, and is configured not to move during adjustment of the curvature of field. The reduction side lens unit L2b has a positive refractive power, and is moved during focusing.

FIGS. 2A to 2C are each a graph for showing an MTF/defocus characteristic with respect to the d-line wavelength in Embodiment 1 of the present disclosure. The MTF is calculated at a spatial frequency of 60 lp/mm of the d-line wavelength. The MTF/defocus characteristics in a case of the on-axis image height and the peripheral image height (7.8 mm) on the liquid crystal panel LD are shown, and correspond to an image center and an image periphery on the screen, respectively. The vertical dotted line of the MTF graph represents an MTF peak position of the on-axis image height, namely, an image plane position of the on-axis angle of field.

FIG. 2A represents an MTF/defocus characteristic with respect to the d-line wavelength in a case where the projected distance is 3,500 mm and a projected image is projected onto the plane screen. The design of Embodiment 1 is based on the plane, and as shown in FIG. 2A, a projection optical system having a small variation in curvature of field from the image center to the image periphery is obtained. However, as described above, when an image is projected onto a surface, which is not a plane like a screen having a curvature, a specific position, for example, the center of the screen, can be focused on similarly to the case of projection onto the plane, whereas image blur occurs at other positions depending on a difference from the plane.

FIG. 2B represents an MTF/defocus characteristic with respect to the d-line wavelength in a case where a projected image is projected onto the curved surface screen having a curvature radius R of 1,750 mm. That is, FIG. 2B represents an MTF/defocus characteristic in a case where the object distance corresponding to the curved surface screen for each image height is changed. The MTF peak position of the meridional image plane moves toward the negative side by about 80 μm with respect to the peripheral image height, and thus an image quality of the image periphery greatly deteriorates.

FIG. 2C represents an example of adjusting the enlargement side lens unit L1b toward the reduction side by 1.86 mm and the reduction side lens unit L2b toward the enlargement side by 0.09 mm so as to change the curvature of field in Embodiment 1. In FIG. 2C, the MTF peak position of the image periphery is improved while the MTF/defocus characteristic on the axis is maintained compared to FIG. 2B. As described above, on the basis of FIGS. 2A to 2C, it is found that an image having a small deviation in focus of the optical axis and having an adjustable curvature of field, which is more satisfactory than an unadjusted image, is obtained.

FIG. 8 is an illustration of an example of application of the two exemplary projection optical systems according to Embodiment 1 to a hemisphere screen having a curvature radius R of 1,750 mm. As illustrated in FIG. 8, a projection type display apparatus P1 and a projection type display apparatus P2, which use the projection optical system according to Embodiment 1, are arranged opposite to each other, to thereby be able to project an image onto a screen surface of the hemispherical dome. The above-mentioned peripheral image height (7.8 mm) corresponds to a vertex of the hemisphere screen. Through adjustment of the above-mentioned curvature of field, it is possible to obtain a satisfactory image for the entire screen surface of the hemispherical dome.

In this manner, in Embodiment 2, a lens unit that adjusts the curvature of field is arranged in both of the first optical system L1 and the second optical system L2, to thereby be able to greatly change the curvature of field and handle a projected surface having a larger curvature.

In Embodiment 2, the first optical system L1 includes an L1a lens unit L1a and an enlargement side lens unit L1b in order from the enlargement conjugate side to the reduction conjugate side. The L1a lens unit L1a has a negative refractive power, and is configured not to move during adjustment of the curvature of field. Further, the first optical system L1 includes an L1c lens unit L1c and an L1d lens unit L1d. The L1c lens unit L1c has a positive refractive power, and is configured not to move during adjustment of the curvature of field. The L1d lens unit L1d has a positive refractive power, and is moved during focusing. The enlargement side lens unit L1b has a negative refractive power.

The second optical system L2 includes an L2a lens unit L2a, a reduction side lens unit L2b, and an L2c lens unit L2c in order from the enlargement conjugate side to the reduction conjugate side. The L2a lens unit L2a has a positive refractive power, and is configured not to move during adjustment of the curvature of field. The L2c lens unit L2c has a positive refractive power, and is configured not to move during adjustment of the curvature of field. The reduction side lens unit L2b has a positive refractive power.

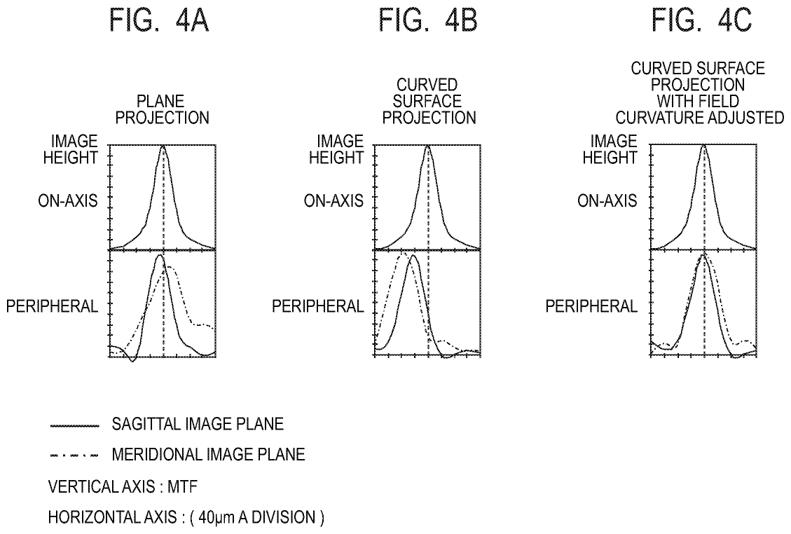

FIGS. 4A to 4C are each a graph for showing an MTF/defocus characteristic with respect to the d-line wavelength in Embodiment 2. The MTF is calculated at a spatial frequency of 60 lp/mm of the d-line wavelength. The MTF/defocus characteristics in a case of the on-axis image height and the peripheral image height (7.8 mm) on the liquid crystal panel LD are shown, and correspond to an image center and an image periphery on the screen, respectively. The vertical dotted line of the MTF graph represents an MTF peak position of the on-axis image height, namely, an image plane position of the on-axis angle of field.

FIG. 4A represents an MTF/defocus characteristic with respect to the d-line wavelength in a case where the projected distance is 2,000 mm and a projected image is projected onto the plane screen. The design of Embodiment 2 is based on the plane, and as shown in FIG. 4A, a projection optical system having a small variation in curvature of field from the image center to the image periphery is obtained.

FIG. 4B represents an MTF/defocus characteristic with respect to the d-line wavelength in a case where a projected image is projected onto the curved surface screen having the curvature radius R of 1,000 mm. That is, FIG. 4B represents an MTF/defocus characteristic in a case where the object distance corresponding to the curved surface screen for each image height is changed. The MTF peak position of the meridional image plane moves toward the negative side by about 80 μm with respect to the peripheral image height, and thus an image quality of the image periphery greatly deteriorates.

FIG. 4C represents an example of adjusting the enlargement side lens unit L1b toward the enlargement side by 0.14 mm and the reduction side lens unit L2b toward the reduction side by 0.09 mm so as to change the curvature of field in Embodiment 2. In FIG. 4C, the MTF peak position of the image periphery is improved while the MTF/defocus characteristic on the axis is maintained compared to FIG. 4B. As described above, on the basis of FIGS. 4A to 4C, it is found that an image having a small deviation in focus of the optical axis and having an adjustable curvature of field, which is more satisfactory than an unadjusted image, is obtained.

In Embodiment 3, the first optical system L1 includes an enlargement side lens unit L1a and an L1b lens unit L1b in order from the enlargement conjugate side to the reduction conjugate side. The L1b lens unit L1b has a positive refractive power, and is configured not to move during adjustment of the curvature of field. The enlargement side lens unit L1b has a negative refractive power.

The second optical system L2 includes an L2a lens unit L2a, a reduction side lens unit L2b, and an L2c lens unit L2c in order from the enlargement conjugate side to the reduction conjugate side. The L2a lens unit L2a has a positive refractive power, and is configured not to move during adjustment of the curvature of field. The L2c lens unit L2c has a positive refractive power, and is configured not to move during adjustment of the curvature of field. The reduction side lens unit L2b has a positive refractive power, and the L2c lens unit L2c is moved during focusing.

In Embodiment 3, a focus adjustment unit and a lens unit that adjusts the curvature of field are provided in a separate manner. Through division of the function in this manner, the focus configuration is simplified, and the curvature of field is adjusted in accordance with the curved surface screen. Further, occurrence of a curvature of field in a case where the back focus has deviated after the lens unit is mounted may be reduced.

Meanwhile, with a method of adjusting the degree of focus change and curvature of field while canceling the change in focus and change in curvature of field of the optical axis by moving two lens units as in Embodiment 1, it is possible to achieve higher optical performance by reducing the weight of the movement lens unit.

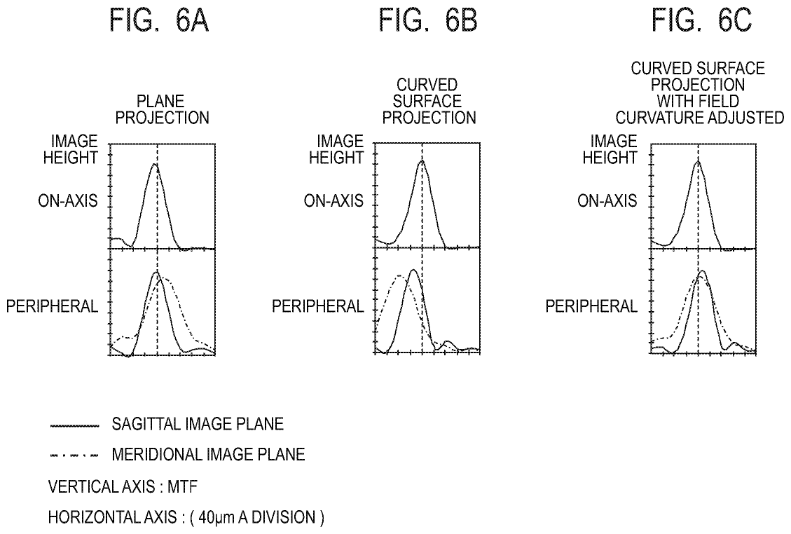

FIGS. 6A to 6C are each a graph for showing an MTF/defocus characteristic with respect to the d-line wavelength in Embodiment 3. The MTF is calculated at a spatial frequency of 60 lp/mm of the d-line wavelength. The MTF/defocus characteristics in a case of the on-axis image height and the peripheral image height (7.8 mm) on the liquid crystal panel LD are shown, and correspond to an image center and an image periphery on the screen, respectively. The vertical dotted line of the MTF graph represents an MTF peak position of the on-axis image height, namely, an image plane position of the on-axis angle of field.

FIG. 6A represents an MTF/defocus characteristic with respect to the d-line wavelength in a case where the projected distance is 2,000 mm and a projected image is projected onto the plane screen. The design of Embodiment 3 is based on the plane, and as shown in FIG. 6A, a projection optical system having a small variation in curvature of field from the image center to the image periphery is obtained.

FIG. 6B represents an MTF/defocus characteristic with respect to the d-line wavelength in a case where a projected image is projected onto the curved surface screen having the curvature radius R of 1,000 mm. That is, FIG. 6B represents an MTF/defocus characteristic in a case where the object distance corresponding to the curved surface screen for each image height is changed. The MTF peak position of the meridional image plane moves toward the negative side by about 80 μm with respect to the peripheral image height, and thus an image quality of the image periphery greatly deteriorates.

FIG. 6C represents an example of adjusting the enlargement side lens unit L1a toward the reduction side by 0.14 mm and the reduction side lens unit L2b toward the enlargement side by 0.54 mm so as to change the curvature of field in Embodiment 3. In FIG. 6C, the MTF peak position of the image periphery is improved while the MTF/defocus characteristic on the axis is maintained compared to FIG. 6B. As described above, on the basis of FIGS. 6A to 6C, it is found that an image having a small deviation in focus of the optical axis and having an adjustable curvature of field, which is more satisfactory than an unadjusted image, is obtained.

Next, with reference to FIG. 7, a description is given of a configuration of a projection type display apparatus (projector) P, which can mount the projection optical system described in each Embodiment of the present disclosure.

In FIG. 7, a light source 1 includes a high pressure mercury lamp, or a light source unit including a solid light source, such as a laser diode or an LED, and a fluorescent substance, and emits white light. An illumination optical system 2 guides light flux emitted from the light source 1 into a color separating/combining optical system 3 described later. The color separating/combining optical system 3 guides light from the illumination optical system 2 into an optical modulation element 4, and guides light from the optical modulation element 4 into a projection optical system 5.

The optical modulation element 4 includes, for example, a reflective liquid panel, and includes a panel for blue color, a panel for green color, and a panel for red color. The optical modulation element 4 modulates blue light, green light, and red light, which are separated by each optical element included in the color separating/combining optical system 3, based on each image signal.

The projection optical system 5 includes the projection optical system described in each Embodiment, and guides light emitted from the optical modulation element 4 via the color separating/combining optical system 3 onto a screen (projected surface) 6. In FIG. 7, the screen 6 is a curved surface screen having a concave shape on the projector P side. Through the above-mentioned configuration in which the projection optical system 5 includes, in order from the enlargement side to the reduction side, the above-mentioned enlargement side lens unit L1b and reduction side lens unit L2b that adjust the curvature of field, the projection type display apparatus P projects an image onto the screen 6, but may further include the following components. That is, the projection type display apparatus P includes a movement adjustment device 7 that adjusts movement of the enlargement side lens unit and the reduction side lens unit in the optical-axis direction in accordance with a command from an operation device, and a shape measurement device that measures the shape of the screen 6 (projected surface). Further, the movement adjustment device 7 may adjusts movement of the enlargement side lens unit and the reduction side lens unit in the optical-axis direction based on information from the shape measurement device.

The movement adjustment device 7 is, for example, a drive device for moving the enlargement side lens unit and the reduction side lens unit in the optical-axis direction, or a drive control device for controlling the drive device. The drive device may be a mechanical component, for example, a cam mechanism for moving the enlargement side lens unit and the reduction side lens unit in the optical-axis direction by the user operating an operation ring, or may be an actuator.

The shape measurement device corresponds to an image pickup optical system 8 and an image pickup element 9, and the image pickup optical system 8 and the image pickup element 9 are included in an image pickup apparatus. The image pickup optical system 8 guides light from the screen 6 onto the image pickup element 9, and transmits information from the image pickup element 9 to the movement adjustment device 7. Then, the movement adjustment device 7 adjusts the positions of the enlargement side lens unit and the reduction side lens unit in the optical-axis direction based on the information.

The user may perform a manual operation (operation device) to adjust movement of the enlargement side lens unit and the reduction side lens unit in the optical-axis direction. However, with the above-mentioned configuration, it is possible to cause a curvature of field that is appropriate for the shape of the screen 6 automatically depending on the shape of the screen 6, and thus it becomes easier to reduce a load on the user.

Numerical Data 1 to Numerical Data 3, which correspond to Embodiments 1 to 3, are shown below.

A surface number is a number assigned to a surface of each lens in order from the enlargement conjugate side to the reduction conjugate side. A curvature radius of each lens surface is represented by “r”, a surface distance is represented by “d”, and a refractive index and an abbe number with respect to the d-line (587.56 nm) of a material are represented by “nd” and “vd”, respectively. A lens surface having “*” (asterisk) assigned on the right side of the surface number indicates the fact that the surface has an aspherical shape that follows the following function, and coefficients thereof are shown in the numerical data. A conic coefficient is represented by K, a coordinate in a radial direction is represented by “y”, and a coordinate in the optical-axis direction is represented by “z”. A paraxial curvature radius is represented by R. Fourth-order, sixth-order, eighth-order, and tenth-order aspherical coefficients are represented by A4, A6, A8, and A10, respectively.

z=(y²/R)/((1+(1−y²·k/R²)^{0.3})+A4·y⁴+A6·y⁶+A8·y⁸+A10·y¹⁰

In the following numerical data, the focal length of the entire projection optical system is represented by an absolute value Ifi. An intermediate imaging position is formed inside the projection optical system lens, and thus an image on the last image plane is an erect image. Accordingly, the focal length of the entire system may take a negative value depending on its definition. However, the refractive power of the entire system is positive, and thus the focal length is represented by the absolute value. This holds true also for other data of Embodiments. The focal length of each lens unit is also shown in the numerical data.

Further, numerical values of Conditional Expressions (1), (2), (3), and (4) for the projection optical system according to each Embodiment are shown in Table 1.

(Numerical Data 1)

| Surface | | | | |
|---|---|---|---|---|
| number | r | d | nd | νd |
| 1* | 54.596 | 3.50 | 1.88300 | 40.8 |
| 2 | 16.000 | 11.00 | | |
| 3* | 22.344 | 3.00 | 1.49700 | 81.5 |
| 4 | 14.706 | (Variable) | | |
| 5 | −211.175 | 2.00 | 1.85478 | 24.8 |
| 6 | 26.460 | 5.07 | 1.63246 | 63.8 |
| 7 | −66.667 | 3.30 | | |
| 8 | 90.243 | 2.60 | 1.78650 | 50.0 |
| 9 | −28.809 | (Variable) | | |
| 10 | −42.283 | 2.00 | 1.95906 | 17.5 |
| 11 | 21.487 | 0.41 | | |
| 12 | 292.331 | 0.93 | 1.88500 | 30.2 |
| 13 | −30.778 | 5.98 | | |
| 14 | 293.669 | 4.29 | 1.43875 | 94.7 |
| 15 | −13.406 | 21.70 | | |
| 16 | 57.645 | 4.80 | 1.85025 | 30.1 |
| 17 | −309.483 | 1.34 | | |
| 18 | 22.273 | 7.03 | 1.85025 | 30.1 |
| 19 | 55.556 | (Variable) | | |
| 20* | −11.408 | 2.00 | 1.80809 | 22.8 |
| 21 | 1,118.297 | 4.73 | | |
| 22 | −15.095 | 3.67 | 1.88500 | 30.2 |
| 23 | −13.883 | 9.18 | | |
| 24 | 88.928 | 5.41 | 1.69560 | 59.0 |
| 25 | −36.191 | 0.50 | | |
| 26 | 28.785 | 3.29 | 1.80810 | 22.8 |
| 27 | 153.183 | 11.62 | | |
| 28 | −32.931 | 1.50 | 1.62536 | 35.6 |
| 29 | 24.203 | 8.05 | | |
| 30 (Stop) | ∞ | 10.86 | | |
| 31 | 18.350 | 10.28 | 1.43875 | 94.7 |
| 32 | −35.537 | (Variable) | | |
| 33 | −15.652 | 1.50 | 1.92119 | 24.0 |
| 34 | 4,029.917 | 5.00 | | |
| 35 | 260.240 | 7.88 | 1.43875 | 94.7 |
| 36 | −29.017 | 0.10 | | |
| 37 | 135.317 | 6.18 | 1.59522 | 67.7 |
| 38* | −35.408 | (Variable) | | |
| 39 | −36.136 | 5.02 | 1.43385 | 95.2 |
| 40 | −26.848 | (Variable) | | |
| 41 | ∞ | 38.70 | 1.51633 | 64.1 |
| 42 | ∞ | 3.43 | | |
| 43 | ∞ | 19.50 | 1.80518 | 25.4 |
| 44 | ∞ | 2.00 | | |
| Image plane | | | | |

Aspherical surface data

| | | | |
|---|---|---|---|
| First surface | | | |
| K = 0.00000e+000 | A4 = 8.80010e−006 | A6 = −8.70650e−009 | A8 = 9.44051e−012 |
| Third surface | | | |
| K = 0.00000e+000 | A4 = 6.59749e−005 | A6 = −4.99813e−008 | A8 = 7.32054e−010 |
| Twentieth surface | | | |
| K = 0.00000e+000 | A4 = −2.20816e−005 | A6 = 3.15978e−007 | A8 = 1.04873e−009 |
| Thirty-eighth surface | | | |
| K = 0.00000e+000 | A4 = 1.45454e−005 | A6 = 5.36648e−009 | A8 = 9.74013e−012 |
| A10 = 7.43975e−015 | | | |

| | |
|---|---|
| Focal length | 8.16 |
| F-number | 3.00 |
| Angle of field | 57.88 |
| d4 | 11.96 |
| d9 | 2.14 |
| d19 | 23.12 |
| d32 | 7.73 |
| d38 | 2.71 |
| d40 | 4.00 |

| Unit | First surface | Focal length |
|---|---|---|
| L1a | 1 | −18.60 |
| L1b | 5 | 28.55 |
| L1c | 10 | 17.08 |
| L2a | 20 | 21.90 |
| L2b | 33 | 205.19 |
| L2c | 39 | 206.92 |

(Numerical Data 2)

| Surface | | | | |
|---|---|---|---|---|
| number | r | d | nd | νd |
| 1* | 41.510 | 2.00 | 1.76385 | 48.5 |
| 2 | 13.916 | 7.56 | | |
| 3 | 22.389 | 1.50 | 1.43875 | 94.7 |
| 4 | 8.790 | (Variable) | | |
| 5* | 48.542 | 1.00 | 1.63980 | 34.5 |
| 6 | 9.065 | 11.34 | | |
| 7 | −13.172 | 2.88 | 1.43875 | 94.9 |
| 8 | −11.141 | (Variable) | | |
| 9 | 20.720 | 1.00 | 1.51742 | 52.4 |
| 10 | 11.014 | 6.14 | 1.43875 | 94.7 |
| 11 | −16.334 | 0.15 | | |
| 12 (Stop) | ∞ | 0.15 | | |
| 13 | 20.261 | 4.75 | 1.43875 | 94.7 |
| 14 | −12.268 | 1.00 | 1.88300 | 40.8 |
| 15 | 121.106 | (Variable) | | |
| 16 | 35.891 | 3.47 | 1.88100 | 40.1 |
| 17 | −23.383 | 7.80 | | |
| 18 | −13.248 | 0.80 | 1.85478 | 24.8 |
| 19 | −48.543 | 0.96 | | |
| 20 | −15.277 | 1.00 | 1.85478 | 24.8 |
| 21 | 124.424 | 2.25 | | |
| 22 | 19.534 | 5.30 | 2.00069 | 25.5 |
| 23* | −20.903 | (Variable) | | |
| 24 | 157.801 | 5.08 | 1.59522 | 67.7 |
| 25 | −31.390 | 1.50 | | |
| 26 | 86.497 | 1.50 | 1.80810 | 22.8 |
| 27 | 29.773 | 13.84 | | |
| 28 | 89.857 | 3.51 | 1.84666 | 23.9 |
| 29 | −69.499 | (Variable) | | |
| 30 | −91.017 | 4.40 | 1.43875 | 94.7 |
| 31 | −28.809 | (Variable) | | |
| 32 | 40.144 | 4.26 | 1.43875 | 94.7 |
| 33 | −21.846 | 1.30 | 1.66565 | 35.6 |
| 34 | 27.328 | 5.00 | | |
| 35 | −19.173 | 1.50 | 1.91082 | 35.3 |
| 36 | −30.100 | 0.10 | | |
| 37 | 30.929 | 6.86 | 1.43875 | 94.7 |
| 38 | −25.349 | 3.60 | | |
| 39 | −35.683 | 1.94 | 1.55332 | 71.7 |
| 40* | −27.212 | (Variable) | | |
| 41 | ∞ | 38.70 | 1.51633 | 64.1 |
| 42 | ∞ | 3.43 | | |
| 43 | ∞ | 19.50 | 1.80518 | 25.4 |
| 44 | ∞ | 9.78 | | |
| Image plane | | | | |

Aspherical surface data

| | | | |
|---|---|---|---|
| First surface | | | |
| K = 3.48651e+000 | A4 = 2.84442e−005 | A6 = −7.00711e−008 | A8 = 1.47856e−010 |
| A10 = −1.16444e−013 | | | |
| Fifth surface | | | |
| K = 0.00000e+000 | A4 = −1.10120e−004 | A6 = −1.76192e−007 | A8 = −1.29230e−008 |
| A10 = 4.93398e−011 | | | |
| Twenty-third surface | | | |
| K = 0.00000e+000 | A4 = 2.48581e−004 | A6 = −1.26765e−006 | A8 = 5.26975e−009 |
| A10 = −1.34301e−011 | | | |
| Fortieth surface | | | |
| K = −1.04625e+000 | A4 = 1.01709e−005 | A6 = 1.13959e−008 | A8 = 1.21312e−010 |

| | |
|---|---|
| Focal length | 8.18 |
| F-number | 3.00 |
| Angle of field | 57.82 |
| d4 | 6.06 |
| d8 | 2.01 |
| d15 | 2.39 |
| d23 | 40.57 |
| d29 | 42.85 |
| d31 | 1.00 |
| d40 | 8.29 |

| Unit | First surface | Focal length |
|---|---|---|
| L1a | 1 | −13.57 |
| L1b | 5 | −26.24 |
| L1c | 9 | 31.49 |
| L1d | 16 | 21.52 |
| L2a | 24 | 41.51 |
| L2b | 30 | 94.04 |
| L2c | 32 | 200.93 |

(Numerical Data 3)

| Surface | | | | |
|---|---|---|---|---|
| number | r | d | nd | νd |
| 1* | 46.597 | 3.50 | 1.88300 | 40.8 |
| 2 | 16.000 | 11.00 | | |
| 3* | 28.655 | 3.00 | 1.49700 | 81.5 |
| 4 | 15.939 | (Variable) | | |
| 5 | −52.341 | 2.00 | 1.85478 | 24.8 |
| 6 | 40.015 | 4.80 | 1.63246 | 63.8 |
| 7 | −105.710 | 3.31 | | |
| 8 | 370.254 | 3.40 | 1.78650 | 50.0 |
| 9 | −28.718 | 5.70 | | |
| 10 | −46.753 | 2.00 | 1.95906 | 17.5 |
| 11 | 27.607 | 0.42 | | |
| 12 | 204.148 | 1.23 | 1.88500 | 30.2 |
| 13 | −30.350 | 5.30 | | |
| 14 | 58.178 | 4.50 | 1.43875 | 94.7 |
| 15 | −16.124 | 17.29 | | |
| 16 | 245.105 | 2.94 | 1.85025 | 30.1 |
| 17 | −178.194 | 7.63 | | |
| 18 | 20.878 | 8.46 | 1.85025 | 30.1 |
| 19 | 55.556 | (Variable) | | |
| 20* | −12.263 | 2.00 | 1.80809 | 22.8 |
| 21 | −785.256 | 4.00 | | |
| 22 | −23.735 | 5.63 | 1.88500 | 30.2 |
| 23 | −17.369 | 9.18 | | |
| 24 | 161.032 | 6.54 | 1.69560 | 59.0 |
| 25 | −39.723 | 0.50 | | |
| 26 | 42.963 | 3.82 | 1.80810 | 22.8 |
| 27 | 1,002.049 | 20.86 | | |
| 28 | −22.089 | 1.50 | 1.62536 | 35.6 |
| 29 | 28.221 | 0.65 | | |
| 30 (Stop) | ∞ | 10.86 | | |
| 31 | 47.605 | 5.77 | 1.43875 | 94.7 |
| 32 | −27.851 | (Variable) | | |
| 33 | −57.105 | 1.50 | 1.92119 | 24.0 |
| 34 | 1,528.331 | 5.00 | | |
| 35 | 299.572 | 8.58 | 1.43875 | 94.7 |
| 36 | −28.620 | 0.48 | | |
| 37 | −94.675 | 1.60 | 1.59522 | 67.7 |
| 38* | −85.177 | (Variable) | | |
| 39 | 52.710 | 8.35 | 1.43385 | 95.2 |
| 40 | −66.969 | (Variable) | | |
| 41 | ∞ | 38.70 | 1.51633 | 64.1 |
| 42 | ∞ | 3.43 | | |
| 43 | ∞ | 19.50 | 1.80518 | 25.4 |
| 44 | ∞ | 2.71 | | |
| Image plane | | | | |

Aspherical surface data

| | | | |
|---|---|---|---|
| First surface | | | |
| K = 0.00000e+000 | A4 = 8.82160e−006 | A6 = −1.01616e−008 | A8 = 1.31424e−011 |
| Third surface | | | |
| K = 0.00000e+000 | A4 = 7.26778e−005 | A6 = −4.04721e−008 | A8 = 5.58849e−010 |
| Twentieth surface | | | |
| K = 0.00000e+000 | A4 = −3.00624e−005 | A6 = 2.31179e−007 | A8 = 9.89551e−010 |
| Thirty-eighth surface | | | |
| K = 0.00000e+000 | A4 = 6.31375e−006 | A6 = 5.31125e−010 | A8 = 1.76980e−011 |
| A10 = −1.51238e−014 | | | |

| | |
|---|---|
| Focal length | 8.17 |
| F-number | 3.00 |
| Angle of field | 57.86 |
| d4 | 11.60 |
| d19 | 19.43 |
| d32 | 8.32 |
| d38 | 0.00 |
| d40 | 4.00 |

| Unit | First surface | Focal length |
|---|---|---|
| L1a | 1 | −18.67 |
| L1b | 5 | 22.07 |
| L2a | 20 | 38.62 |
| L2b | 33 | 255.39 |
| L2c | 39 | 69.45 |

TABLE 1

| Conditional | | | |
|---|---|---|---|
| Expression | Embodiment 1 | Embodiment 2 | Embodiment 3 |
| Conditional | 3.4983 | 3.2075 | 2.2862 |
| Expression (1) | | | |
| Conditional | 25.1406 | 11.4963 | 31.2671 |
| Expression (2) | | | |
| Conditional | 7.1345 | 5.5718 | 10.7758 |
| Expression (3) | | | |
| Conditional | 11.5581 | 12.5212 | 12.0161 |
| Expression (4) | | | |

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2019-000955, filed Jan. 8, 2019, which is hereby incorporated by reference herein in its entirety.

What is claimed is:

1. A projection optical system comprising, in order from an enlargement conjugate side to a reduction conjugate side, a first optical system and a second optical system,
wherein the projection optical system has an intermediate imaging position between the first optical system and the second optical system,
wherein an enlargement side lens unit included in the first optical system and a reduction side lens unit included in the second optical system are moved on an optical axis to adjust a curvature of field of an image projected onto the enlargement conjugate side, and
wherein a conditional expression
4.0<|dF/f|<15.0,
is satisfied in a case where f represents a focal length of the projection optical system, and dF represents a distance between a surface vertex of a surface closest to a reduction side of the enlargement side lens unit and the intermediate imaging position of the projection optical system with respect to a d-line wavelength at being focused on infinity.

2. The projection optical system according to claim 1, wherein a conditional expression
1.5<|fF/f|<10.0,
is satisfied in a case where fF represents a focal length of the enlargement side lens unit.

3. The projection optical system according to claim 1, wherein a conditional expression
6.0<|fR/f|<40,
is satisfied in a case where fR represents a focal length of the reduction side lens unit.

4. The projection optical system according to claim 1, wherein a conditional expression
8.0<|dR/f|<15.0,
is satisfied in a case where dR represents a distance between the intermediate imaging position of the projection optical system with respect to the d-line wavelength at being focused on infinity and a surface vertex of a surface closest to an enlargement side of the reduction side lens unit.

5. The projection optical system according to claim 1, wherein each of the enlargement side lens unit and the reduction side lens unit is composed of one lens unit.

6. The projection optical system according to claim 1,
wherein the first optical system includes, in order from the enlargement conjugate side to the reduction conjugate side, an L1a lens unit that has a negative refractive power and is not moved for adjusting the curvature of field, the enlargement side lens unit, and an L1c lens unit that has a positive refractive power and is not moved for adjusting the curvature of field, and
wherein the enlargement side lens unit has a positive refractive power.

7. The projection optical system according to claim 6,
wherein the second optical system includes, in order from the enlargement conjugate side to the reduction conjugate side, an L2a lens unit that has a positive refractive power and is not moved for adjusting the curvature of field, the reduction side lens unit, and an L2c lens unit that has a positive refractive power and is not moved for adjusting the curvature of field, and
wherein the reduction side lens unit has a positive refractive power and is moved for focusing.

8. The projection optical system according to claim 1, wherein the first optical system includes, in order from the enlargement conjugate side to the reduction conjugate side, an L1a lens unit that has a negative refractive power and is not moved for adjusting the curvature of field, the enlargement side lens unit, an L1c lens unit that has a positive refractive power and is not moved for adjusting the curvature of field, and an L1d lens unit that has a positive refractive power and is moved for focusing, and
wherein the enlargement side lens unit has a negative refractive power.

9. The projection optical system according to claim 8,
wherein the second optical system includes, in order from the enlargement conjugate side to the reduction conjugate side, an L2a lens unit that has a positive refractive power and is not moved for adjusting the curvature of field, the reduction side lens unit, and an L2c lens unit that has a positive refractive power and is not moved for adjusting the curvature of field, and
wherein the reduction side lens unit has a positive refractive power.

10. The projection optical system according to claim 1,
wherein the first optical system includes, in order from the enlargement conjugate side to the reduction conjugate side, the enlargement side lens unit, and an L1b lens unit that has a positive refractive power and is not moved for adjusting the curvature of field, and
wherein the enlargement side lens unit has a negative refractive power.

11. The projection optical system according to claim 10,
wherein the second optical system includes, in order from the enlargement conjugate side to the reduction conjugate side, an L2a lens unit that has a positive refractive power and is not moved for adjusting the curvature of field, the reduction side lens unit, and an L2c lens unit that has a positive refractive power and is not moved for adjusting the curvature of field,
wherein the reduction side lens unit has a positive refractive power, and
wherein the L2c lens unit is moved for focusing.

12. A projection type display apparatus comprising:
an optical modulation element that modulates light from a light source; and
a projection optical system that guides light from the optical modulation element onto a surface to be projected,
wherein the projection optical system includes, in order from an enlargement conjugate side to a reduction conjugate side, a first optical system and a second optical system,
wherein the projection optical system has an intermediate imaging position between the first optical system and the second optical system,
wherein an enlargement side lens unit included in the first optical system and a reduction side lens unit included in the second optical system are moved on an optical axis to adjust a curvature of field of an image projected onto the enlargement conjugate side, and
wherein a conditional expression
4.0<|dF/f|<15.0,
is satisfied in a case where f represents a focal length of the projection optical system, and dF represents a distance between a surface vertex of a surface closest to a reduction side of the enlargement side lens unit and the intermediate imaging position of the projection optical system with respect to a d-line wavelength at being focused on infinity.

13. The projection type display apparatus according to claim 12, further comprising:
an operation device that instructs movement of the enlargement side lens unit and the reduction side lens unit in an optical-axis direction; and
a movement adjustment device that adjusts the movement of the enlargement side lens unit and the reduction side lens unit in accordance with an operation of the operation device.
